(19) United States
(12) Patent Application Publication
(10) Pub. No.: US 2013/0035060 A1
(43) Pub. Date: Feb. 7, 2013

(54) SYSTEM AND METHOD FOR ACQUIRING BANDWIDTH FOR CELLUAR COMMUNICATIONS THROUGH COMPETITIVE BIDDING PROCESSES

(71) Applicants: Boris Kai-Tik Chan, Toronto (CA); Sundeep Singh Madra, Palo Alto, CA (US); Jonathan Mikhail, Toronto (CA); David Protasowski, Oshawa (CA); Sina Sojoodi, Toronto (CA); Amar Varma, Toronto (CA)

(72) Inventors: Boris Kai-Tik Chan, Toronto (CA); Sundeep Singh Madra, Palo Alto, CA (US); Jonathan Mikhail, Toronto (CA); David Protasowski, Oshawa (CA); Sina Sojoodi, Toronto (CA); Amar Varma, Toronto (CA)

(73) Assignee: XTREME LABS INC., Toronto (CA)

(21) Appl. No.: 13/562,882

(22) Filed: Jul. 31, 2012

Related U.S. Application Data
(60) Provisional application No. 61/513,824, filed on Aug. 1, 2011.

(51) Int. Cl. H04W 4/24; G06Q 20/40; G06Q 30/08; H04W 72/04; H04W 72/08

(52) U.S. Cl. 455/406; 455/452.1

(57) ABSTRACT

A method is provided for acquiring bandwidth on a mobile device. A bid for bandwidth service on the mobile device is submitted to service providers, which includes: a bandwidth requisition, a plurality of service criteria (each with a weighting factor), and at least one limiting condition (e.g. a maximum price). Responses from the service providers are evaluated using the weighting factors to compute a score. The best scoring response that meets the at least one limiting condition is automatically chosen, and a transaction is entered into with the chosen service provider to acquire the bandwidth service on the mobile device according to the service criteria. The bid may also be submitted to (and the transaction negotiated with) a central bidding server which intermediates bids received from many users.

### CROSS REFERENCE TO RELATED APPLICATION

This application claims priority from U.S. Provisional Application No. 61/513,824 filed on Aug. 1, 2011, which is incorporated by reference in its entirety herein.

### BACKGROUND

All cellular phone networks worldwide use a portion of the radio frequency spectrum designated as Ultra High Frequency for the transmission and reception of their signals. The sets of frequency ranges within this band that have been allocated for cellular phone use vary worldwide, but are generally grouped by standards. Each standard defines the carrier frequency ranges and channel access method used by compatible radio communication technologies. For example, two predominant standards include Global System for Mobile Communications (GSM) and Code Division Multiple Access (CDMA).

Further, for each standard, mobile devices wishing to access the carrier's network must support radio communication on the carrier frequency ranges transmitted by the carrier's broadcast towers, which varies by country. For example, while common world GSM frequencies include 900 MHz (GSM-900 and its derivatives) and 1800 MHz (DCS-1800), 850 MHz (GSM-850) and 1900 MHz (PCS-1900) are used in North America instead. As a result of these discrepancies, mobile device manufacturers introduced tri-band and subsequently quad-band products, which are designed to accommodate a greater number of common carrier frequency ranges.

Despite these compatibility advances within any given standard, most mobile devices are still limited to supporting a set of frequency ranges within a single standard. For example, a quad-band GSM mobile device will not be compatible with CDMA standards, and vice-versa. This reality is not only costly to manufacturers, who must release iterations of their products for various standards, but detrimental to consumers as well, who must limit their selection to devices compatible with their choice of carrier. Furthermore, this carrier selection can be limiting in its own right, often preventing usage of compatible hardware beyond the geographical boundaries of the carrier itself.

Although technology advances and increased competition have meant more choices of service provider (carrier) have become available, one problem is that users are unable to switch frequently between service providers to take advantage of better rates or better service. It would be desirable to have a means to perform this switching with less hassle to users. Frequent switching would also allow providers to allocate spectrum bandwidth to users and/or applications with the specific need for that bandwidth (and/or more willingness to pay at competitive rates).

### SUMMARY

According to a first aspect of the invention, a method is provided for acquiring bandwidth on a mobile device. A bid for bandwidth service for the mobile device is formed, which includes: a bandwidth requisition; a plurality of service criteria (each with a weighting factor); and at least one limiting condition for the bandwidth requisition. The bid is submitted to a plurality of service providers. Upon receiving a response from at least one of the service providers, the response is automatically evaluated by using the weighting factors to compute a score. The scores are compared and the best scoring response that meets the at least one limiting condition is chosen, and a transaction is entered into with the service provider to acquire the bandwidth service on the mobile device (according to the service criteria).

Note that the scoring can be done locally on the device or remotely (e.g. may be tabulated by the service provider based on the user's stated preferences—therefore, returned in the “response”—or may be tabulated by a third party intermediary system—such as the central bidding server referred to below).

At least one of the service criteria, weighting factors, and limiting conditions is preferably entered by the user. At least one of the bandwidth requisition, service criteria, and limiting conditions is preferably automatically formulated by the mobile device.

A maximum price may be entered by the user as a limiting condition, and/or a desired price may be one of the service criteria (that has its own weighting factor).

Frequency range may be a limiting condition.

Preferably, the service criteria includes at least one of price, performance, quality of service, reliability, and availability of required bandwidth.

The service criteria may include a service provider desirability index. This may be based on the user's subjective assessment (e.g. based on the user's past experience with the service provider). Alternatively, the service provider desirability index may be assigned based on other objective or subjective factors. One factor may be the user's preferred customer status with that service provider (e.g. membership in a loyalty program where the user gets points or preferred rates). In one embodiment, the service provider desirability index may be assigned based on polling data retrieved from social media.

The user may also assign certain service providers a preferred service provider status (or this may be automatic based on past experience or transactions of the user or other users with this service provider). Preferred service provider status may be a limiting condition, or it may be one service criteria to be weighted among others.

In one embodiment, the service criteria and limiting conditions are retrieved from service criteria and limiting conditions previously entered by the user. In this case, the pre-entered service criteria and limiting conditions may simply be verified by the user when the bid is made (need not be re-entered) (or this verification may be simply skipped altogether, and the service can be transacted more or less automatically after the service criteria and limiting conditions are entered once by the user).

The bandwidth requisition may be automatically formulated based on a service request from the user (e.g. where the service request is a request for a voice or data operation on the mobile device). In one embodiment, the bandwidth requisition is automatically formulated at periodic intervals during a voice or data operation.

The bandwidth requisition may also be automatically formulated in the event of a failure of or poor performance during a voice or data operation.

Transacting with the service provider preferably comprises providing a payment. This payment can be in the form of one or more credits. Providing the payment may include providing authorization to deduct from a payment method. This payment may be pre-authorized before the bandwidth requisition.

In one embodiment, the bid is submitted to a plurality of service providers via a central bidding server, which intermediates bids from a plurality of users of mobile devices. The responses may be received from the service providers via the central bidding server, and some or all of the transaction may also occur via the central bidding server.

The process may repeat, e.g. if no response is received that meets the service criteria and the limiting conditions. The process may repeat until a response is received, or a minimum score is reached. In a competitive bidding embodiment (with multiple users seeking bandwidth through bids submitted to the central bidding server), the process may repeat with an incrementally increased desired price (within the user's pre-set maximum price limiting condition).

### BRIEF DESCRIPTION OF THE DRAWINGS

FIG. 1A is an overview of the wireless communications involved between the client and providers when there is direct service negotiation.

FIG. 1B provides an overview of the process of competitive bidding for services directly between client and spectrum providers.

FIG. 2A is an overview of the wireless communications involved between the client and providers when there is intermediated (brokered) service negotiation.

FIG. 2B provides an overview of the process of competitive bidding for services between client and spectrum providers that is intermediated (brokered) by a third party.

FIG. 3 is a sample heuristic in the bidding process.

### DETAILED DESCRIPTION

Systems and methods disclosed herein provide an improved service to mitigate at least some of the aforementioned disadvantages of the current methodology.

The system is comprised of clients, which in embodiments are mobile devices as well as software residing in the mobile device, and the backend servers of mobile data service providers (also known as “spectrum”or “bandwidth”, “providers” or “carriers”). In one embodiment, the system also includes a central bidding server that arbitrates interactions between client and providers. The method involves interactions between the client, provider and, in some embodiments, the bidding server. This method defines a process in which a central bidding server performs real-time evaluation of available spectrum providers on behalf of clients in order to bid for data transfer usage in exchange for credits.

Before embodiments of the invention are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

It should also be noted that the invention is not limited to any particular software language described or implied in the figures and that a variety of alternative software languages may be used for implementation of the invention.

Many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviors that other programming languages might perform during compilation. JavaScript, PHP, Perl, Python and Ruby are examples of dynamic languages. Additionally computer code may also be written using a web programming stack of software, which may mainly be comprised of open source software, usually containing an operating system, Web server, database server, and programming language. LAMP (Linux, Apache, MySQL and PHP) is an example of a well-known open-source Web development platform. Other examples of environments and frameworks in which computer code may also be generated are Ruby on Rails which is based on the Ruby programming language, or node.js which is an event-driven server-side JavaScript environment.

The program code may execute entirely on the client device, partly on the client device, as a stand-alone software package, partly on the client device and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A device that enables a user to engage with an application using the invention, including a memory for storing a control program and data, and a processor (CPU) for executing the control program and for managing the data, which includes user data resident in the memory and includes buffered content. The computer may be coupled to a video display such as a television, monitor, or other type of visual display while other devices may have it incorporated in them (iPad). An application or a game or other simulation may be stored on a storage media such as a DVD, a CD, flash memory, USB memory or other type of memory media or it may be downloaded from the internet. The storage media can be inserted to the console where it is read. The console can then read program instructions stored on the storage media and present a user interface to the user.

In some embodiments, the device is portable. In some embodiments, the device has a display with a graphical user interface (GUI), one or more processors, memory and one or more modules, programs or sets of instructions stored in the memory for performing multiple functions.

It should be understood that although the term application has been used as an example in this disclosure in essence the term may also apply to any other piece of software code where the embodiments of the invention are incorporated. The software application can be implemented in a standalone configuration or in combination with other software programs and is not limited to any particular operating system or programming paradigm described here. Thus, this invention intends to cover all applications and user interactions described above as well as those obvious to the ones skilled in the art.

The computer program comprises: a computer usable medium having computer usable program code, the computer usable program code comprises: computer usable program code for presenting graphically to the users options for scrolling via the touch-screen interface.

Several exemplary embodiments/implementations of the invention have been included in this disclosure. There may be other methods obvious to persons skilled in the art, and the intent is to cover all such scenarios. The application is not limited to the cited examples, but the intent is to cover all such areas that may be benefit from this invention.

The device may include but is not limited to a personal computer (PC), which may include but not limited to a home PC, corporate PC, a Server, a laptop, a Netbook, a Mac, a cellular phone, a Smartphone, a PDA, an iPhone, an iPad, an iPod, an iPad, a PVR, a set-top box, wireless enabled Blu-ray player, a TV, a SmartTV, wireless enabled Internet radio, e-book readers e.g. Kindle or Kindle DX, Nook, etc. and other such devices that may be used for the viewing and consumption of content whether the content is local, is generated on demand, is downloaded from a remote server where is exists already or is generated as a result. Client devices and server devices (or systems) may be running any number of different operating systems as diverse as Microsoft Windows family, MacOS, iOS, any variation of Google Android, any variation of Linux or Unix, PalmOS, Symbian OS, Ubuntu or such operating systems used for such devices available in the market today or the ones that will become available as a result of the advancements made in such industries.

The rationale for this invention is that when the networks become dumb pipes, users should be able to bid and get voice/data/text etc. from any network that offers the best value to meet their needs.

Users can have many kinds of preferences, they may rank the networks based on reliability, service, speed etc., prefer cheapest or the most reliable, cheapest block of text messages, best value for day time voice minutes etc.

Specifically, mobile devices supporting a wide range of frequency ranges will natively support a process in which acquired credits of predetermined value will be exchanged against data transfer usage, offered from one of many available spectrum providers, dubbed billing services. Providers will be able to offer as many of a number of frequency ranges as they are authorized to represent, at a momentary rate subject to their determination. At ongoing intervals, clients will query available providers and make a determination as to which represents the best available option for current data requirements, based on a predetermined set of criteria, including but not limited to, price, performance, reliability, available bandwidth and past experience. The querying and negotiations for service between client and provider may be direct or intermediated (brokered) by a third party, the bidding server.

The present invention offers numerous useful benefits. Credits will be offered through a variety of channels, at a variety of prices, taking advantage of competitive market forces, as well as promotional and cross-product offers. This process will permit a more open and competitive marketplace in which carriers of all sizes can compete for business within the wireless spectrum. Subsequently, market forces will yield greater competition and choice of carriers, leading to better overall consumer satisfaction. Mobile client device manufacturers will be able to standardize components to support a greater spectrum of frequencies, eventually reducing manufacturing costs while simultaneously reaching a broader range of both consumers and carriers.

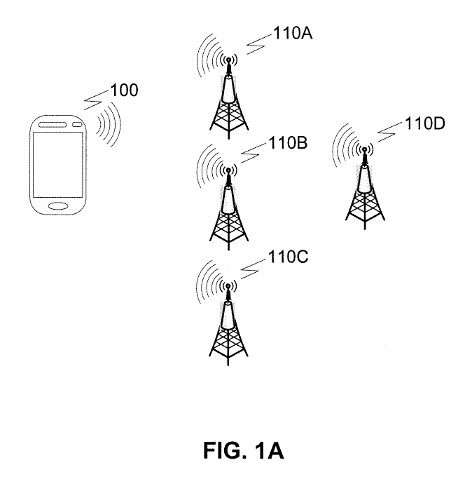

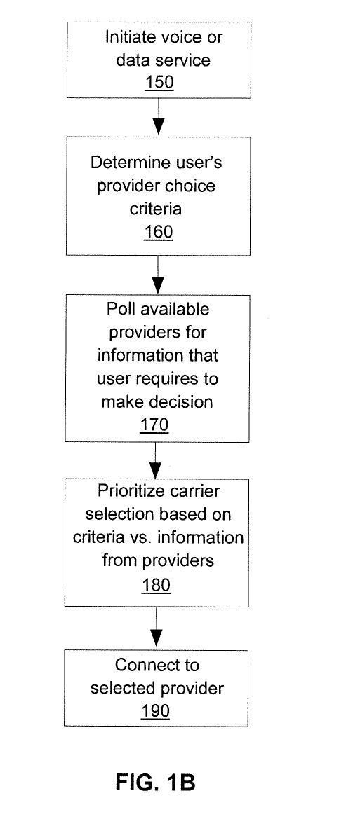

In one embodiment of the present invention, the client (through the mobile device) and spectrum provider negotiate directly. This type of scenario is illustrated very simply in FIGS. 1A and 1B.

Referring to FIG. 1A, a mobile device 100 supporting an arbitrary range of frequencies and having previously acquired an arbitrary number of credits (which can be used to purchase bandwidth/capacity), queries available spectrum providers within range. Four providers 110A, B, C, D respond, each relaying their available frequencies, requested rates and other relevant specifications. One provider 110D operates on frequencies not supported by the mobile device, and is ignored. Of the three remaining, the mobile device 100 evaluates that one provider 110C offers the most competitive offer and accepts to exchange a number of credits in exchange for a certain amount of data access. Once the predetermined amount of data has been expended, the process is repeated.

FIG. 1B elaborates on the evaluation of the most competitive offer previously described from the viewpoint of the mobile device. More specifically, this is the major stages of events that occur within the software that runs on the mobile device.

Referring to FIG. 1B stage 150, under direction of the user, or in an alternative embodiment of the invention, automatically, the mobile device initiates the process of obtaining competitive bids. In a further alternative embodiment of the present invention, the device or central bidding server (described below) may automatically solicit further competitive bids as an application continues, for example, every 15 minutes during a voice over IP conversation. If a more competitive bid was received then the device or central bidding server could switch providers one or more times as the application continues.

Referring to FIG. 1B stage 160, the software determines user preferences according to preconfigured priority such as price, performance, reliability, available bandwidth and past experience. In an embodiment of the invention the user preferences will depend on application specific characteristics such as the application employed and the particular request that has been made within the application. The user preferences could also include a preference for one service provider compared to another service provider. The user preferences could also include a generic willingness to accept a lower level of performance during some situations compared to other situations. For example, a person may choose to have good quality performance while conducting a voice over IP conversation and may choose a lower level of performance when accessing or playing a game over the cellular network.

Referring to FIG. 1B stage 170, the system (software and mobile device) polls spectrum providers within communication range for information in the user's preference list. Alternatively, the provider may be polled for all available information which the software can then selectively evaluate which avoids the need for stage 160. The information may be transmitted using various protocols including XML.

Referring to FIG. 1B stage 180, the software then performs a calculation with the available inputs. The calculations utilize a formula that applies a weighting factor to user preferences. For example, price may be a high priority and is assigned a greater weight than other available criteria such as performance, reliability, available bandwidth and past experience with that particular carrier or provider in a formula. Objective, mathematical criteria such as performance, reliability and available bandwidth may be determined by the system of the present invention. Since these are dependent on many factors such as location, differing spectrum providers may be more optimal under some circumstances than others. Subjective criteria such as past experience may be available by allowing data input by the user. Some criteria may also be dynamic and may be sourced from online services. For example, past experience may be a rating of spectrum providers maintained at an online social networking site. In such a case, data exchange is provided by an application programming interface provided by the social networking site and mathematical is obtained for purposes of input into the formula. The formula returns a score for the available spectrum providers in such a way that rank is assigned.

Referring to FIG. 1B stage 190, the software attempts to establish a network connection using the list of spectrum providers ranked in the previous stage. The network connection is for the purpose of using the services offered by the spectrum provider rather than the data exchange in stage 170.

In another embodiment and best mode of the present invention, a third party (a central bidding server) intermediates the negotiation between mobile client device user and spectrum provider.

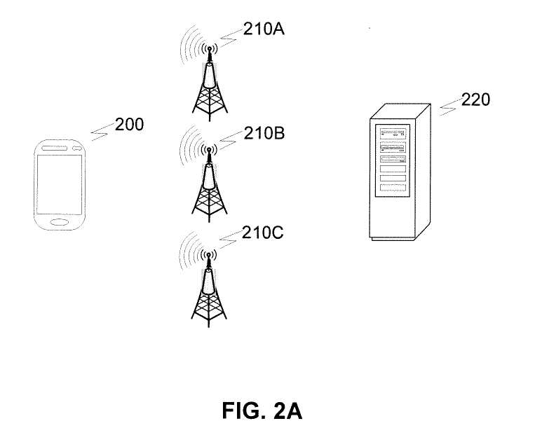

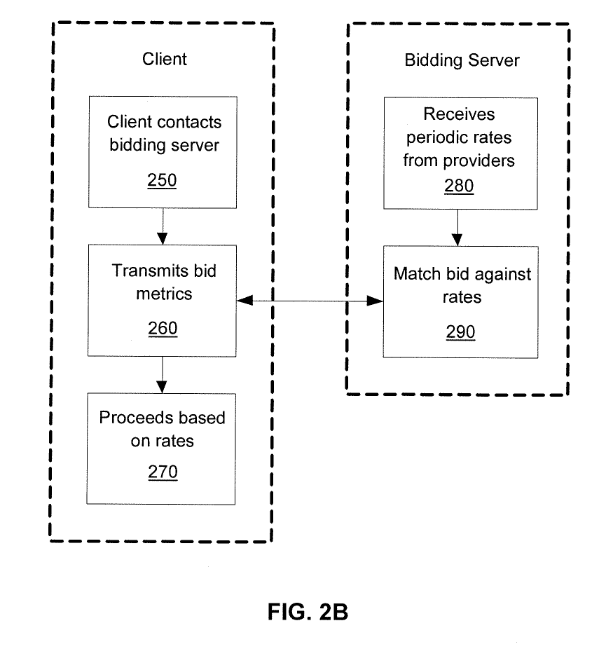

Referring to FIG. 2A, a mobile client device 200 transmits a query to the central bidding server 220 via an available network in order to make the initial contact with the server. This network may include a wired connection, WiFi or it may be one of the default spectrum providers 210A, B, C within range. In the case of the latter, the spectrum provider chosen by the bidding process in the present invention determines which spectrum provider will ultimately be used for the remainder of the session. The central server 220 is connected to the spectrum providers 210A, B, C by variable means including a wide area network. Once the server performs the evaluation and transaction of credits, it transmits information for the client and selected provider to connect. This can be accomplished by pushing instructions to the mobile device 200 or to the provider.

Referring to FIG. 2B stage 250, the evaluation process for provider selection initiates when the client contacts the central bidding server. Once connection is established, in stage 260 the client provides bid metrics. This includes maximum payment limit for the purposes of bidding for services. It may also include others such as desired network quality of service, required bandwidth speeds, etc. The bidding server determines which provider to use transparent to the client which proceeds to use available service at stage 270.

Requests are preferably sent via piggy back off data, or off voice or in another embodiment can be managed outside of the device as part of billing management. For example the user can use a website to register the device and then bid for whatever is needed either via this site or from the device.

A web interface may be provided for users. However, the user will preferably not need to access the web interface every time a new service request is made. The idea is that a user can set preferences, thresholds, limits, etc. and then the bidding can go ahead when these criteria are met. Once user sets preferences, the whole system can preferably operate more or less invisibly (transparently) to the user (i.e. switching between providers and deducting credits from an account on the fly). At other times, the user may be more involved (e.g. making a choice between equal scoring providers). Preferably, the user can make changes and check on the current status, and be notified of the choices and upcoming events. In one embodiment, the user may get a final user confirmation before a bid is entered or before a transaction proceeds.

Referring to FIG. 2B stage 280, the central bidding server is in constant communications with providers' servers as depicted in FIG. 2A where they exchange information. Referring to stage 290, the central server has updated providers' rates which are compared to current clients' bids. The system may in some cases need to arbitrate between identical (or equal score) bids received at the same time. Business rules provided in the system can handle this. Various tie-breaking methods may be used, including without limitation, by first-come first-serve, previous customer loyalty or metrics that can be determined at the time of the bids being processed. Repeat customers may get preference. The central server then is able to optimize clients' bids against providers' rates. Heuristics may also include other evaluation such as network quality of service, required bandwidth and other desired specifications provided by the client. This process can be configured to repeat at specified time intervals such that at any given moment, credits paid by the client remain optimized such that the provider used by the client may change from time to time. Since clients and providers can dynamically adjust their rates, the central server's role is to constantly apply the bidding process heuristics.

In any embodiment, whether negotiations between client and provider occur directly or mediated by a central server, the core logic in the bidding process is identical.

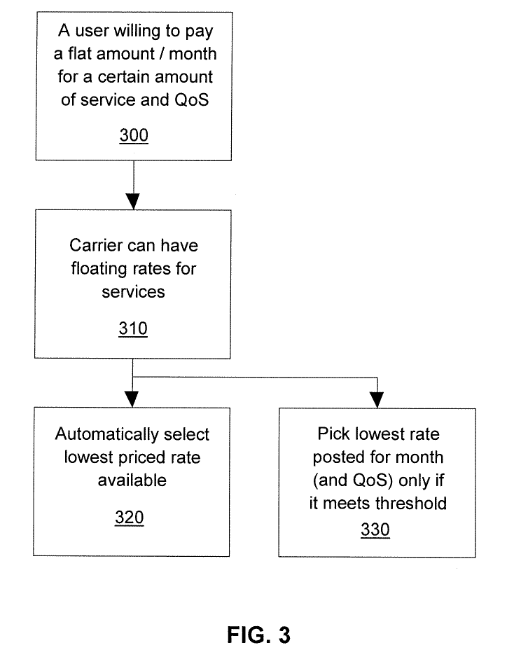

In the most typical case, heuristics of the bidding process is such that clients receive competitive service for the lowest number of credits (price). FIG. 3 depicts the logic which applies to the typical case. A user is willing to pay a flat amount per month for a certain amount of service and a quality of service (QoS) 300. The carrier (service provider) may have a floating rate for services 310. The heuristics of the method weigh the user's preferences (service criteria) and any limiting conditions. In one instance, the preferences may drive the system to simply select the cheapest possible rate 320. In another instance, the preferences may drive the system to look at both the rate and the QoS and take into account any threshold set by the user (e.g. maximum price or minimum bandwidth requirement) 330. The preferences can also be context-sensitive (e.g. higher rate tolerance if higher QoS required for a particular operation).

Credits may be typical monetary instruments or such indirect payments such as “travel miles” or “reward points”. Credits may also include prepaid cash credits, instead of arbitrary credits. Credits that a client has may be kept at an online payment service which holds the credits. These credits can then be accessed, depending on the embodiment, by the spectrum provider or central bidding server. Ultimately, credits are transferred from the client to the provider in exchange for service. Alternatives to credits as payment may be used such as advertisements received by the client in exchange for services.

The actual purchase of data access from a provider may occur at various points (when the credits are purchased, when the credits are “redeemed” to start the service, or after the service is used). In one preferred embodiment, access is realtime on successful bidding. That is, the user is buying data/voice/access based on live marketing conditions in an auction environment. After-user settlement of credits may also occur. A continuous account may be maintained that may be topped up by the user from time to time (or pre-authorized credit card on file).

The financial settlements can be structured various ways. The user may pay the intermediary who pays the providers, or the user may pay the provider(s) directly. Funds may also be pooled and allocated by percentage among the providers.

The agreement between the user and the service provider can be based on terms—an example would be a level of access over a certain time period (like a data plan for a month) or it can be on-demand usage (500 MBs of data, for a certain period e.g. 1 month)—terms and expiry dates and policies should all be part of what gets purchased (i.e. notified/accessible to the user at the time of bidding).

The credits may themselves fluctuate in value in a competitive bidding scenario. The value can thus be based on market conditions. If the user has prepaid with real money, the user's currency account will generally not change in value. However, the relative value of services that are being bid upon can go up (thus resulting in a relative decrease in the purchasing power of the currency/credits).

In one scenario the user may have prepaid a certain amount (say $100) to the operator and each successful bid is adjusted against this balance. Another can be that the user has registered their credit card with the operator and each successful bid is charged against this card.

Users should be able to rank providers (there may be loyalty programs tied to them). The system preferably allows the device user to set limits on what he/she is willing to pay for, and to automatically bid and get access to the best price and fit that is on the market for the services that the user wants (e.g. I want to pay max 10 dollars for 1 GB of data for a month).

The intent of the application is to cover all such combinations and permutations not listed here but that are obvious to the ones skilled in the art. The above examples are not intended to be limiting, but are illustrative and exemplary.

The examples noted here are for illustrative purposes only and may be extended to other implementation embodiments. While several embodiments are described, there is no intent to limit the disclosure to the embodiment(s) disclosed herein. On the contrary, the intent is to cover all alternatives, modifications, and equivalents obvious to those familiar with the art.

What is claimed is:

1. A method of acquiring bandwidth on a mobile device, comprising:
forming a bid for bandwidth service for a mobile device, including:
a bandwidth requisition;
a plurality of service criteria for the bandwidth requisition, and a weighting factor for each of the service criteria; and
at least one limiting condition for the bandwidth requisition;
submitting the bid to a plurality of service providers;
upon receiving a response from at least one of the service providers, automatically evaluating each response by using the weighting factors to compute a score for each said response; and
automatically choosing the best scoring response that meets the at least one limiting condition and transacting with the service provider to acquire the bandwidth service on the mobile device.

2. The method of claim 1, wherein at least one of the service criteria, weighting factors, and limiting conditions is entered by the user.

3. The method of claim 1, wherein at least one of the bandwidth requisition, service criteria, and limiting conditions is automatically formulated by the mobile device.

4. The method of claim 1, wherein a maximum price is entered by the user as a limiting condition.

5. The method of claim 1, wherein the service criteria includes a desired price.

6. The method of claim 1, wherein frequency range is a limiting condition.

7. The method of claim 1, wherein the service criteria includes at least one of price, performance, quality of service, reliability, and availability of required bandwidth.

8. The method of claim 1, wherein the service criteria includes a service provider desirability index.

9. The method of claim 8, wherein the service provider desirability index is assigned based on the user's subjective assessment.

10. The method of claim 8, wherein the service provider desirability index is assigned based on the user's subjective assessment based on the user's past experience with the service provider.

11. The method of claim 8, wherein the service provider desirability index is assigned based on the user's preferred customer status with that service provider.

12. The method of claim 8, wherein the service provider desirability index is assigned based on polling data retrieved from social media.

13. The method of claim 1, wherein service providers may be assigned preferred service provider status.

14. The method of claim 13, wherein preferred service provider status is a limiting condition.

15. The method of claim 13, wherein preferred service provider status is a service criteria.

16. The method of claim 1, wherein the service criteria and limiting conditions are retrieved from service criteria and limiting conditions previously entered by the user.

17. The method of claim 1, wherein pre-entered service criteria and limiting conditions are verified by the user when the bid is made.

18. The method of claim 1, wherein the bandwidth requisition is automatically formulated based on a service request from the user.

19. The method of claim 18, wherein the service request is a request for a voice or data operation on the mobile device.

20. The method of claim 1, wherein the bandwidth requisition is automatically formulated at periodic intervals during a voice or data operation.

21. The method of claim 1, wherein the bandwidth requisition is automatically formulated in the event of a failure of or poor performance during a voice or data operation.

22. The method of claim 1, wherein transacting with the service provider comprises providing a payment.

23. The method of claim 22, wherein the payment is in the form of one or more credits.

24. The method of claim 22, wherein providing the payment includes providing authorization to deduct from a payment method.

25. The method of claim 22, wherein the payment is pre-authorized before the bandwidth requisition.

26. The method of claim 1, wherein the bid is submitted to a plurality of service providers via a central bidding server, which intermediates bids from a plurality of users of mobile devices.

27. The method of claim 26, wherein the responses are received from the service providers via the central bidding server.

28. The method of claim 26, wherein transacting with the service provider occurs via the central bidding server.

29. The method of claim 1, wherein if no response is received that meets the service criteria and the limiting conditions, the process repeats until a response is received.

30. The method of claim 29, wherein the process repeats with an incrementally increased desired price.
